(19) United States
(12) Patent Application Publication
(10) Pub. No.: US 2012/0293141 A1
(43) Pub. Date: Nov. 22, 2012

(54) BRIDGELESS PFC CONVERTER AND THE METHOD THEREOF

(75) Inventors: Bo Zhang, Hangzhou (CN); Yuancheng Ren, Hangzhou (CN); Junming Zhang, Hangzhou (CN); James C. Moyer, San Jose, CA (US); Eric Yang, Saratoga, CA (US)

(73) Assignee: Chengdu Monolithic Power Systems Co., Ltd., Chengdu (CN)

(21) Appl. No.: 13/474,545

(22) Filed: May 17, 2012

(30) Foreign Application Priority Data
May 17, 2011 (CN) 201110127485.7

(51) Int. Cl. G05F 1/70

(52) U.S. Cl. 323/207

(57) ABSTRACT

A bridgeless PFC (power factor correction) converter with improved efficiency is disclosed. The bridgeless PFC converter comprises: input terminals configured to receive an input AC power supply; an output terminal configured to provide power supply; a high frequency bridge arm comprising a first switch and a third switch coupled between the output terminal and a ground node; a low frequency bridge arm comprising a second switch and a fourth switch coupled between the output terminal and the ground node; an inductor coupled between the input AC power supply and the high frequency bridge arm; and a control circuit configured to control the switching of switches in the high frequency bridge arm and the low frequency bridge arm.

### CROSS-REFERENCE TO RELATED APPLICATION(S)

This application claims priority to and the benefit of Chinese Patent Application No. 201110127485.7, filed May 17, 2011, which is incorporated herein by reference in its entirety.

### TECHNICAL FIELD

The present invention relates generally to AC-DC converters, and more particularly but not exclusively to AC-DC power supplies and the method thereof.

### BACKGROUND

The conventional AC-DC converter, for example, PFC (Power Factor Correct) converter, comprises a bridge rectifier and a boost converter. FIG. 1A schematically shows a prior art PFC converter with COT (Constant On Time) control. The PFC converter comprises a main circuit 101 and a control circuit 102. The main circuit 101 comprises a bridge rectifier and a boost converter. The bridge rectifier comprises diodes D1˜D4. An AC power supply having a first terminal “L” and a second terminal “N” is supplied to the input terminals of the bridge rectifier. Output terminals of the bridge rectifier are coupled to input terminals of the boost converter. The boost converter comprises an inductor L1, a switch S1, a diode D5 and an output capacitor Co coupled as shown. An output voltage Vo is supplied to a load represented by a resistor R_{L}.

The control circuit 102 is shown in FIG. 1A. The control circuit 102 further comprises a sense circuit (not shown) detecting a current flowing through the inductor L1 and the output voltage Vo, wherein based on the current flowing through the inductor L1, the sense circuit generates a zero current detecting signal ZCD, and wherein based on the output voltage Vo, the sense circuit generates a feedback signal U_{F}. The sense circuit is familiar to persons of ordinary skill in the art and is not described here for brevity. The control circuit 102 receives the zero current detecting signal ZCD and the feedback signal U_{F}, and based on the zero current detecting signal ZCD and the feedback signal U_{F}, the control circuit 102 generates a switching signal H to control the switch S1. The control circuit 102 comprises a compensating circuit to compensate the feedback signal U_{F}. The compensating circuit comprises an operational amplifier AMP, a resistor R1 and a capacitor C1. The compensated feedback signal is coupled to an inverting input terminal of a second comparator Comp2. A non-inverting input terminal of the second comparator Comp2 is configured to receive a ramp signal RAMP. Based on the compensated feedback signal and the ramp signal RAMP, the second comparator Comp2 generates a constant on time signal COT to control the on time of the switch S1. The zero current detecting signal ZCD is coupled to an inverting input terminal of a first comparator Comp1. A non-inverting input terminal of the first comparator Comp1 is configured to receive a reference signal VZ. An output signal of the first comparator Comp1 is coupled to a set terminal “S” of a RS flip-flop to set the RS flip-flop. An output terminal “Q” of the RS flip-flop provides the switching signal “H”.

FIG. 1B schematically shows another prior art PFC converter. A voltage divider 103 is configured to detect the line voltage rectified by the bridge rectifier. The voltage divider 103 comprises a resistor R2 and a resistor R3. An input voltage detecting signal Vin-rec is provided at the connection node of the resistor R2 and the resistor R3. A sense circuit is configured to sense the current flowing through the switch S1, and generates a current sense signal CS based thereupon. The control circuit 102 receives the zero current detecting signal ZCD, the feedback signal U_{F}, the current sense signal CS and the input voltage detecting signal Vin-rec, and based on the zero current detecting signal ZCD, the feedback signal U_{F}, the current sense signal CS and the input voltage detecting signal Vin-rec, the control circuit 102 generates the switching signal “H” to control the ON and OFF of the switch S1. The control circuit 102 comprises a compensating circuit to compensate the feedback signal U_{F}. The compensating circuit comprises an operational amplifier AMP, a resistor R1 and a capacitor C1. The compensated feedback signal U_{F} is coupled to a first input terminal of a multiplier. The multiplier has a second input terminal configured to receive the input voltage detecting signal Vre-rec. The multiplier multiplies the signal Vin-rec with the compensated feedback signal, and generates a signal Vcom based on the multiplication. A second comparator Comp2 has an inverting input terminal, a non-inverting input terminal and an output terminal, wherein the inverting input terminal is configured to receive the signal Vcom, the non-inverting input terminal is configured to receive the current sense signal CS, and the output terminal is coupled to a reset terminal “R” of a RS flip-flop. A first comparator Comp1 has an inverting input terminal, a non-inverting input terminal and an output terminal, wherein the inverting input terminal is configured to receive the zero current detecting signal ZCD, the non-inverting input terminal is configured to receive a reference signal VZ, and the output terminal is coupled to a set terminal “S” of the RS flip-flop. The switching signal “H” is generated at an output terminal “Q” of the RS flip-flop.

When the current sense signal CS reaches the signal Vcom, the switch S1 is turned OFF. A current supplied by the AC power supply flows through the bridge rectifier, the inductor L1 and a switch D5 to charge the output capacitor Co and to provide power to the load R_{L}. During this period, the inductor L1 is discharged.

The efficiency of the PFC converters in FIG. 1A and FIG. 1B is low. Because in addition to boost converter losses, the input alternating current passes through the two diodes of the full bridge rectifier for either positive or negative portion of an AC cycle in PFC converters in FIGS. 1A and 1B. The diode is inefficient and will result in a high conduction loss.

### SUMMARY

It is an object of the present disclosure to provide a bridgeless PFC converter differ from the prior art and the method thereof.

In accomplishing the above and other objects, there has been provided, in accordance with an embodiment of the present disclosure, a bridgeless PFC converter converting an input AC power supply to a DC power. The bridgeless PFC converter comprises: an inductor; a low frequency bridge arm comprising two switches working at low frequency, wherein a terminal of the input AC power supply is coupled to an connection node of the two switches via the inductor; a high frequency bridge arm comprising two switches working at high frequency; a differential sample circuit coupled to the input AC power supply to detect the state of the input AC power supply; a logic control circuit configured to provide a switching signal based on a zero current detecting signal and a feedback signal; a low frequency bridge arm control circuit configured to control the on and off of the switches of the low frequency bridge arm based on the state of the input AC power supply; a high frequency bridge arm control circuit configured to control the on and off of the switches of the high frequency bridge arm based on the switching signal.

Furthermore, there has been provided, in accordance with an embodiment of the present disclosure, a method of controlling a bridgeless PFC converter, wherein the method comprises: sampling an input AC power supply by a differential sample circuit; generating a switching signal based on a zero current detecting signal and a feedback signal; controlling the switches of a bridge arm working at high frequency; controlling the switches of another bridge arm working at low frequency, and the switches are alternatively turned on and off based on the state of the input AC power supply.

### BRIEF DESCRIPTION OF THE DRAWINGS

FIG. 1A schematically shows a prior art PFC converter with COT (constant ON time) control.

FIG. 1B schematically shows another prior art PFC converter.

FIG. 2A schematically shows a bridgeless PFC converter 201 in accordance with an embodiment of the present disclosure.

FIG. 2B schematically shows a control circuit for the PFC converter 201 in FIG. 2A.

FIG. 3A schematically shows a bridgeless PFC converter 201 in accordance with another embodiment of the present disclosure.

FIG. 3B schematically shows a control circuit for the PFC converter 201 in FIG. 3A.

FIG. 4 shows waveforms of signals of the control circuits in FIG. 2B and 3B.

FIG. 5 shows a flowchart of a method 500 of a voltage converter in accordance with an embodiment of the present disclosure.

The use of the same reference label in different drawings indicates the same of like components.

### DETAILED DESCRIPTION

In the present disclosure, numerous specific details are provided, such as examples of circuits, components, and methods, to provide a thorough understanding of embodiments of the invention. Persons of ordinary skill in the art will recognize, however, that the invention can be practiced without one or more of the specific details. In other instances, well-known details are not shown or described to avoid obscuring aspects of the invention.

It is to be understood in these letters patent that the meaning of “A” is coupled to “B” is that either A and B are connected to each other as described below, or that, although A and B may not be connected to each other as described below, there is nevertheless a device or circuit that is connected to both A and B. This device or circuit may include active or passive circuit elements, where the passive circuit elements may be distributed or lumped-parameter in nature. For example, A may be connected to a circuit element that in turn is connected to B.

In one embodiment, switches in one bridge arm work at low frequency, for example, approximately at the same frequency with an input AC power supply. The reduction of the frequency of the switches in the bridge arm reduces the switching loss, so that the efficiency of the power supplies implemented in accordance with an embodiment of the present disclosure is improved.

In one embodiment, the switches in the bridge arms comprise transistors, for example, MOSFET (Metal Oxide Semiconductor Field Effect Transistor). Compared with diodes, the transistors, like MOSFETs, have lower on resistance resulting in lower conduction loss. Furthermore, there are only two switches working during the whole operation. Thus, the circuits in accordance with embodiments of the present disclosure are especially suitable to the applications of high frequency and/or large current.

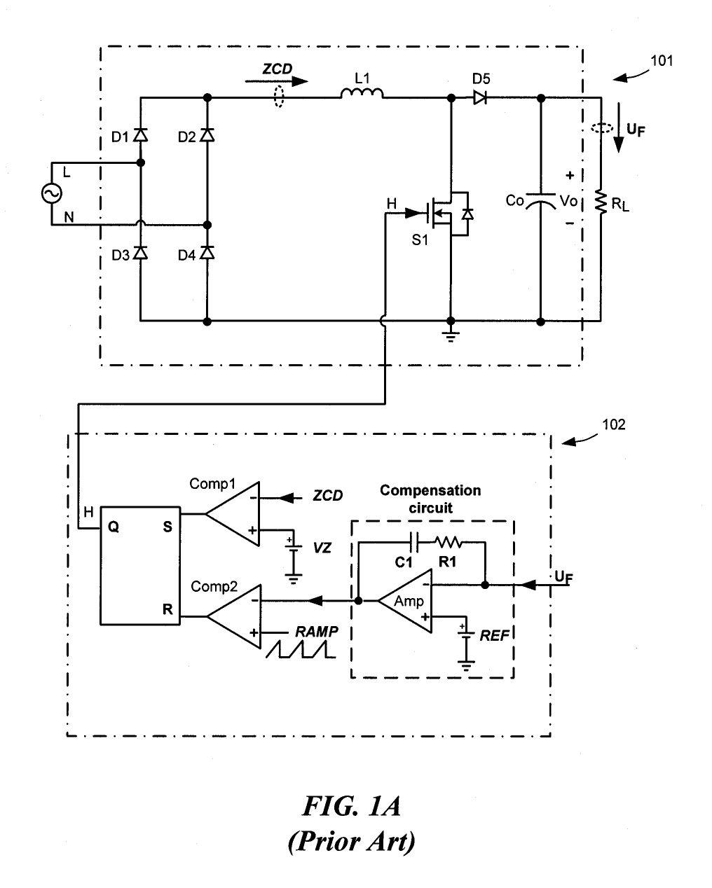

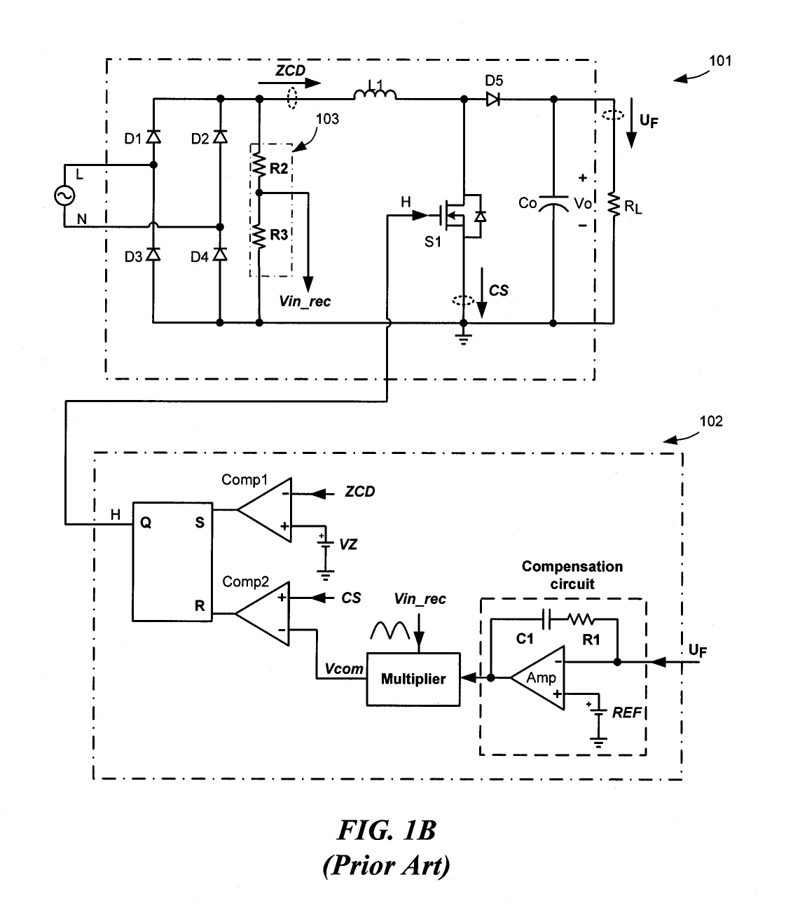

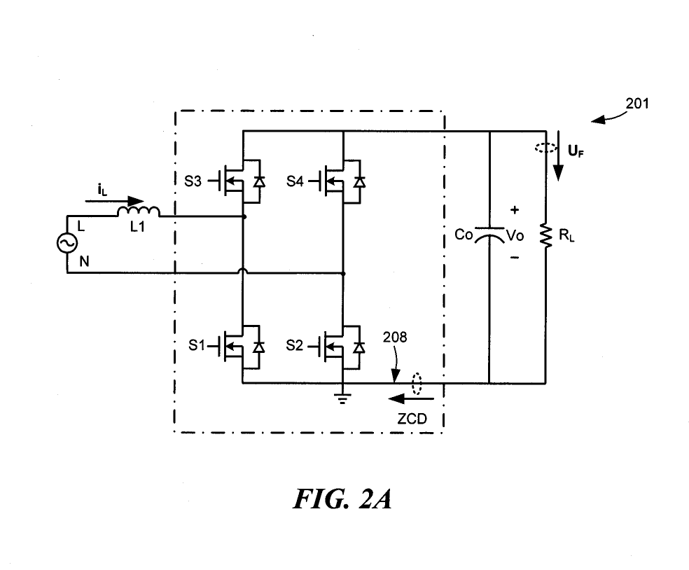

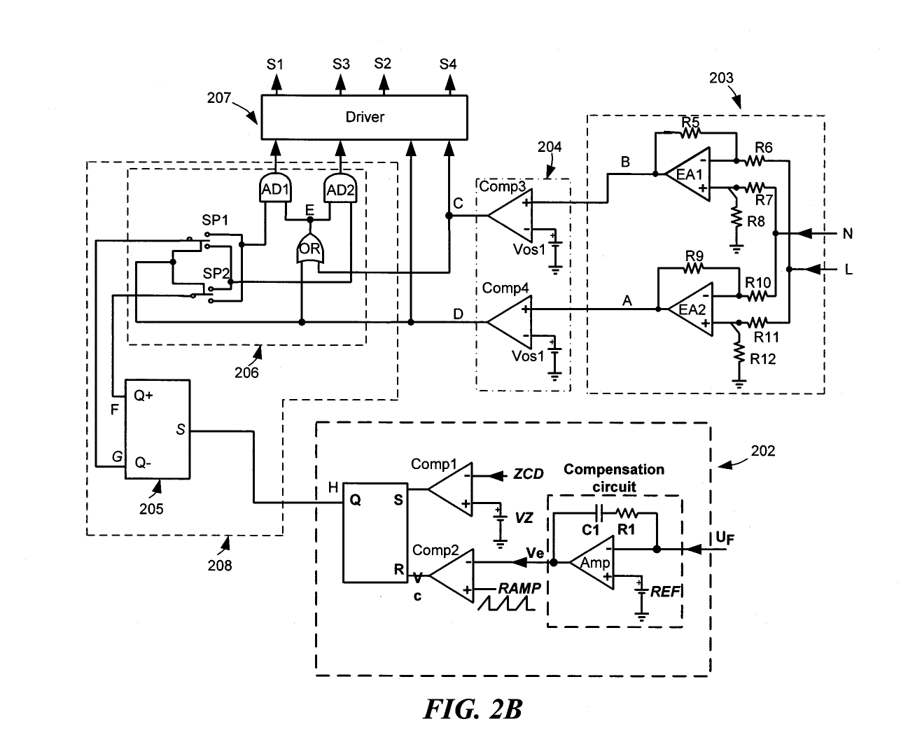

FIG. 2A schematically shows a bridgeless PFC converter 201 in accordance with an embodiment of the present disclosure. Compared to FIG. 1A, the bridge rectifier in FIG. 2A comprises switches S1, S2, S3 and S4 instead of diodes D1, D2, D3 and D4. The switches S1 and S3 constitute a high frequency bridge arm, which means that the switches S1 and S3 operate at high frequency. The switches S2 and S4 constitute a low frequency bridge arm, which means that the switches S2 and S4 operate at low frequency. In one embodiment, the switches S2 and S4 operate at the same frequency with a frequency of an input AC power supply. The inductor L1 is coupled between the input AC power supply and the bridge rectifier, with one terminal coupled to a terminal “L” of the input AC power supply and with the other terminal coupled to the connection node of the switches S1 and S3. A terminal “N” of the input AC power supply is coupled to the connection node of the switches S2 and S4. In the example of FIG. 2A, the switches S1˜S4 comprise MOSFET (Metal Oxide Semiconductor Field Effect Transistor). Persons of ordinary skill in the art should know that the switches S1˜S4 may comprise other suitable transistors. During the operation from the positive portion of the input AC power supply, the switch S2 stays ON, and the switches S1 and S3 are turned ON and OFF alternatively at high frequency. When the switch S1 is ON, the input AC power supply charges the inductor L1 through the loop formed by the inductor L1, the switch S1 and the switch S2; when the ON time of the switch S1 reaches the constant on time COT, the switch S1 is turned OFF and the switch S3 is turned ON, then the input AC power supply charges the output capacitor Co through the loop formed by the inductor L1, the switch S3 and the switch S2. Meanwhile the input AC power supply supplies power to the load R_{L}, and the inductor L1 is discharged. During the operation of the negative portion of the input AC power supply, the switch S4 stays ON. When the switch S3 is ON, the input AC power supply charges the inductor L1 through the loop formed by the inductor L1, the switch S3 and the switch S4; when the ON time of the switch S3 reaches the constant on time COT, the switch S3 is turned OFF, and the switch S1 is turned ON, then the input AC power supply charges the output capacitor Co through the loop formed by the inductor L1, the switch S1 and the switch S4. Meanwhile the input AC power supply supplies power to the load R_{L}, and the inductor L1 is discharged.

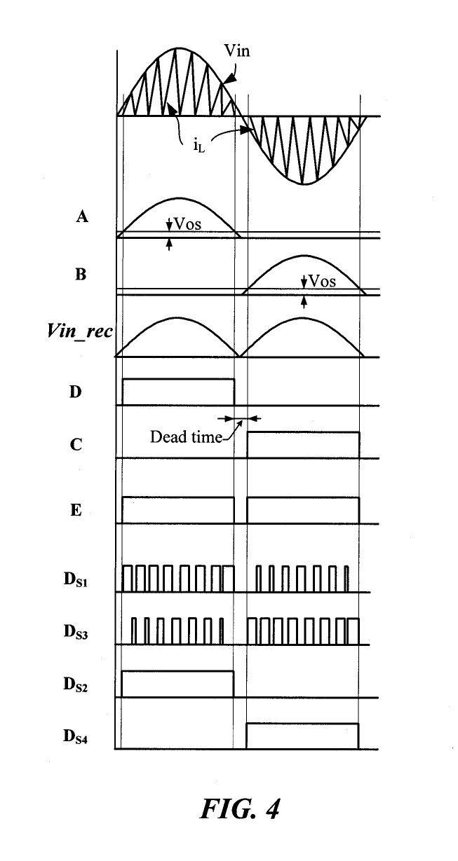

In FIG. 4, 401 represents the waveform of the input AC power supply; 402 represents the current I_{L} flowing through the inductor L1; D_{S1}, D_{S2}, D_{S3} and D_{S4} respectively represents the waveform of the drive signals of the switches S1, S2, S3 and S4. The switch is turned ON when the drive signal is logical high and is turned OFF when the drive signal is logical low. During the operation from the positive portion of the input AC power supply, the switch S2 stays ON: during when the switch S1 is ON and the switch S3 is OFF, the current I_{L} charges the inductor L1 with a rising slope; during when the switch S3 is ON and the switch S1 is OFF, the current I_{L} discharges the inductor L1 with a falling slope. During the operation from the negative portion of the input AC power supply, the switch S4 stays ON: during when the switch S3 is ON and the switch S1 is OFF, the current I_{L} charges the inductor L1 with a rising slope; during when the switch S1 is ON and the switch S3 is OFF, the current I_{L} discharges the inductor L1 with a falling slope.

FIG. 2B schematically shows a control circuit for the PFC converter 201 in FIG. 2A. A sense circuit (not shown) detects a current flowing through the line 208 and generates a zero current detecting signal ZCD based on the detection. Meanwhile, a feedback signal U_{F} indicative of the output voltage Vo is also generated. The zero current detecting signal ZCD and the feedback signal U_{F} are coupled to the logic control circuit 202. Then the logic control circuit 202 generates a switching signal “H” based on the zero current detecting signal ZCD and the feedback signal U_{F}. In one embodiment, the logic control circuit 202 comprises a compensating circuit which compensates the feedback signal U_{F}. The compensating circuit comprises an operational amplifier AMP, a resistor R1 and a capacitor C1. The compensated feedback signal is coupled to an inverting input terminal of a second comparator Comp2. A non-inverting input terminal of the second comparator Comp2 is configured to receive a ramp signal RAMP. Based on the compensated feedback signal and the ramp signal RAMP, the second comparator Comp2 generates a constant on time signal COT. The zero current detecting signal ZCD is coupled to an inverting input terminal of a first comparator Comp1. A non-inverting input terminal of the first comparator Comp1 is configured to receive a first reference signal VZ. Based on the zero current detecting signal ZCD and the first reference signal VZ, the first comparator Comp1 generates a set signal. A RS flip-flop has a set input terminal “S”, a reset input terminal “R” and an output terminal “Q”, wherein the set input terminal “S” is configured to receive the set signal generated by the first comparator Comp1, the reset input terminal “R” is configured to receive the constant on time signal COT, and wherein based on the set signal and the constant on time signal COT, the RS flip-flop generates the switching signal “H” at the output terminal “Q”.

A differential sample circuit 203 is configured to sample the input AC power supply. A first terminal “L” of the power supply is coupled to a first terminal of a resistor R6 and a first terminal of a resistor R11. A second terminal of the resistor R6 is coupled to an inverting input terminal of a first operational amplifier EA1 and a first terminal of a resistor R5. A second terminal of the resistor R5 is coupled to an output terminal of the first operational amplifier EA1. A second terminal of the resistor R11 is coupled to a non-inverting terminal of a second operational amplifier EA2 and a first terminal of a resistor R12. A second terminal of the resistor R12 is connected to a ground node. A second terminal “N” of the power supply is coupled to a first terminal of a resistor R7 and a first terminal of resistor R10. A second terminal of the resistor R7 is coupled to a non-inverting terminal of the first operational amplifier EA1 and a first terminal of resistor R8. A second terminal of the resistor R8 is connected to the ground node. A second terminal of the resistor R10 is coupled to an inverting terminal of the second operational amplifier EA2 and a first terminal of resistor R9. A second terminal of the resistor R9 is coupled to an output terminal of the second operational amplifier EA2. The output signal “A” of the second operational amplifier EA2 is a first detecting signal indicative of the positive portion of the input AC power supply and the output signal “B” of the first operational amplifier EA1 is a second detecting signal indicative of the negative portion of the input AC power supply.

As shown in FIG. 4, 401 represents the waveform of the input AC power supply. The first detecting signal “A” is similar to the positive portion of the input AC voltage. The second detecting signal “B” is similar to the negative portion of the input AC power supply.

A low frequency bridge arm control circuit 204 is configured to control the switches S2 and S4. The output terminal of the first operational amplifier EA1 is coupled to a non-inverting terminal of a third comparator Comp3; and an inverting terminal of the third comparator Comp3 is configured to receive a second reference signal Vos1. An fourth switch control signal “C” generated by the third comparator Comp3 is coupled to a first input terminal of a driver 207. The first detecting signal “A” is coupled to a non-inverting terminal of a fourth comparator Comp4. An inverting terminal of the fourth comparator Comp4 is configured to receive the second reference signal Vos1. A second switch control signal “D” generated by the fourth comparator Comp4 is coupled to a second input terminal of the driver 207. The driver 207 powers its input signals and provides the powered signals to control terminals of the switches to control the ON and OFF of the switches.

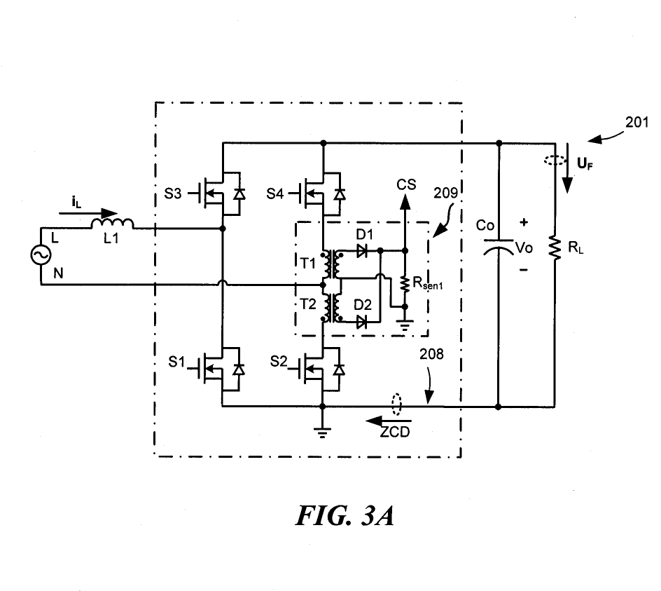

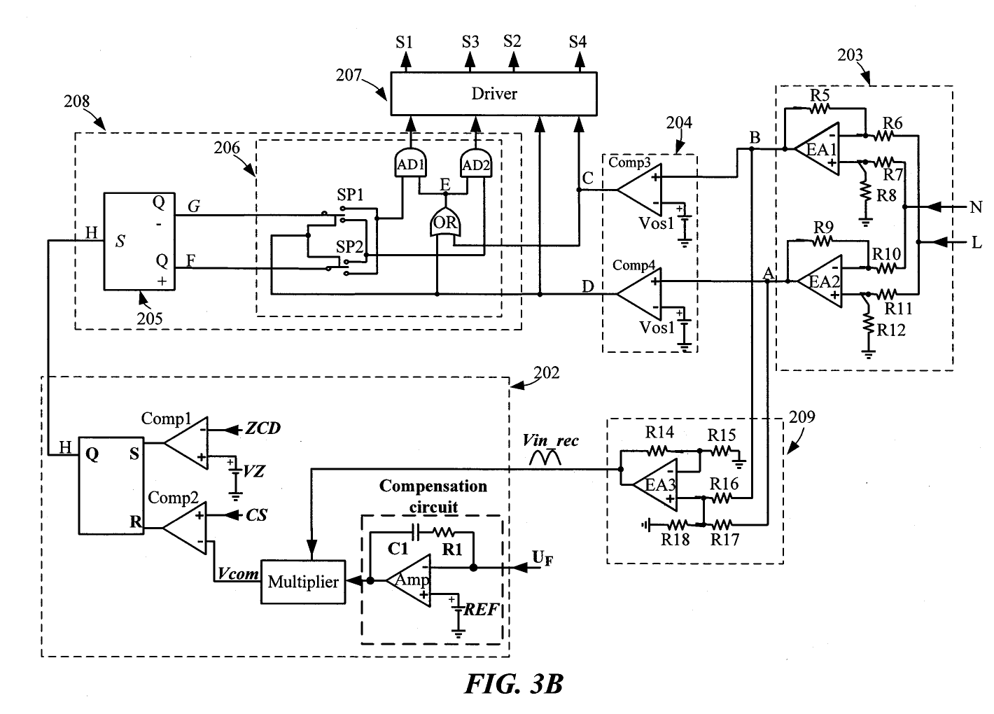

During the operation from the positive portion of the power supply, the voltage at the first terminal “L” is positive, so that the first detecting signal “A” is positive, too. When the first detecting signal “A” is higher than the second reference signal Vos1, the second switch control signal “D” is logical high. The second switch control signal “D” is then powered by the driver 207 to turn ON the switch S2. During the operation from the negative portion of the power supply, the voltage at the first second terminal “N” is positive, so that the second detecting signal “B” is positive, too. When the second detecting signal “B” is higher than the second reference signal Vos1, the fourth switch control signal “C” is logical high. The fourth switch control signal “C” is then powered by the driver 207 to turn ON the switch S4. So the switches S2 and S4 work at almost the same frequency as the frequency of the input AC power supply. The second reference signal Vos1 is adopted to provide a dead time between the switching of the switches S2 and S4. When either the first detecting signal “A” or the second detecting signal “B” is lower than the second reference signal Vos1, the signal “D” or “C” is logical lower, and one of the switches S2 and S4 is turned OFF so that there is no large current flowing directly from the power supply to the ground node. As shown in FIG. 3, the second switch control signal “D” is logical high when the first detecting signal “A” is higher than the second reference signal Vos1; and the second switch control signal “D” is logical high when the second detecting signal “B” is higher than the second reference signal Vos1. There is a dead time between the signals “C” and “D”, so that the signals “C” and “D” will not be both logical high at any time.

A synchronous driver 205 and a signal selector 206 constitute a high frequency bridge arm control circuit. The high frequency bridge arm control circuit provides control signals for switches S1 and S3. The switching signal “H” generated by the logic control circuit 202 is coupled to an input terminal of the synchronous driver 205. The synchronous driver 205 has a first output terminal Q+ and a second output terminal Q− respectively providing a first control signal “F” and a second control signal “G”, wherein the signals “F” and “G” are complementary. There is a delay time TD1 between the rising edge of the switching signal “H” and the falling edge of the second control signal “G”, and also the delay time is between the falling edge of the switching signal “H” and the falling edge of the first control signal “F”. There is a dead time TD2 between the first control signal “F” and the second control signal “G” so that there will be no large current directly from the power supply to the ground node. The signals “F” and “G” are coupled to the signal selector 206. The signal selector 206 provides signals to control the ON and OFF of the switches S1 and S3 based on whether the input AC power supply is positive or negative. As shown in FIG. 2B, the second control signal “G” is coupled to a first terminal of a SPDT (Single-Pole Double-Throw) switch SP1 and the first control signal “F” is coupled to a first terminal of a SPDT switch SP2. The operation of the SPDT switches SP1 and SP2 is controlled by the second switch control signal “D”. A second terminal of the SPDT switch SP1 is coupled to a third terminal of the SPDT switch SP2, and a signal “M” is provided at the connection node. A third terminal of the SPDT switch SP1 is coupled to a second terminal of the SPDT switch SP2, and a signal “N” is provided at the connection node.

During the operation from the positive portion of the power supply, the second switch control signal “D” is logical high, thus the signal “M” is similar to the second control signal “G”, and the signal “N” is similar to the first control signal “F”, which means M=G, N=F. During the operation from the negative portion of the power supply, the second switch control signal “D” is logical low, thus the signal “M” is similar to the first control signal “F”, and the signal “N” is similar to the second control signal “G”, which means M=F, N=G. The signal “M” is coupled to a first input terminal of an AND gate AD1, and an output signal of the AND gate AD1 is coupled to an input terminal of the driver 207 to control the ON and OFF of the switch S1; The signal “N” is coupled to a first input terminal of a AND gate AD2, and an output signal of the AND gate AD2 is coupled to an input terminal of the driver 207 to control the ON and OFF of the switch S3. The signals “C” and “D” are coupled to an OR gate OR to generate a signal “E”. The signal “E” is coupled to a second input terminal of the AND gate AD1 and a second input terminal of the AND gate AD2. During the dead time between the fourth switch control signal “C” and the second switch control signal “D”, the signal “E” is logical low, and then the output signals of the AND gates AD1 and AD2 are both logical low. Thus the switches S1 and S3 are turned OFF; during when the fourth switch control signal “C” is logical high or the second switch control signal “D” is logical high, the signal “E” is logical high, and then the AND gates AD1 and AD2 transmit the signals “M” and “N” to the driver 207. Persons of ordinary skill in the art should know that any circuits could perform the function of the signal selector 206 described above could be used without detracting the merits of the present disclosure.

In one embodiment, there are only two switches working during the whole operation. And one of the two switches works at low frequency, for example, approximately the same with the frequency of the input AC power supply. The reduction of the frequency of the switches in the bridge arm reduces the switching loss, so that improves the efficiency of the power supplies realized in accordance with an embodiment of the present disclosure. Thus, the circuits in accordance with embodiments of the present disclosure are especially suitable to the application of high frequency and large current.

FIG. 3A schematically shows a bridgeless PFC converter 201 in accordance with an embodiment of the present disclosure. FIG. 3B schematically shows a control circuit for the PFC converter 201 in FIG. 3A. In the example of FIG. 3A, a current sense circuit 209 is configured to sense the current flowing through the switches S2 and S4, wherein the current sense circuit 209 comprises: a first current transformer T1 and a second current transformer T2 respectively coupled in series with the switch S4 and the switch S2; a first diode D1 configured to couple the current flowing through the fourth switch S4 to a sense resistor Rsen1; and a second diode D2 configured to couple the current flowing through the second switch S2 to the sense resistor Rsen1. The sense resistor Rsen1 has a first terminal and a second terminal, wherein the first terminal is connected to the ground node. A current sense signal CS is generated at the second terminal of the sense resistor Rsen1 and is provided to an input terminal of the logic control circuit 202 in FIG. 3B. Persons of ordinary skill in the art should know that any suitable current sense circuit could be used without detracting the merits of the present disclosure.

In the embodiment of FIG. 3B, the output terminals of the differential sample circuit 203 are further coupled to a summing circuit 210. The second detecting signal “B” is coupled to a first terminal of a resistor R16, and the first detecting signal “A” is coupled to a first terminal of a resistor R17. A second terminal of the resistor R16, a second terminal of the resistor R17 and a first terminal of a resistor R18 are coupled together to a non-inverting input terminal of a third operational amplifier EA3. A second terminal of the resistor R18 is coupled to the ground node. An output terminal of the third operational amplifier EA3 is coupled to an input terminal of the logic control circuit 202 and a second terminal of a resistor R14. A second terminal of the resistor R14 is coupled to an inverting input terminal of the third operational amplifier EA3 and a second terminal of a resistor R15. A first terminal of the resistor R15 is connected to the ground node. FIG. 4 schematically shows the waveform of an input voltage detecting signal Vin-rec generated by the third operational amplifier EA3. The input voltage detecting signal Vin-rec is a sum of the first detecting signal “A” and the second detecting signal “B”. The logic control circuit 202 generates the switching signal “H” based on the zero current detecting signal ZCD, the feedback signal U_{F}, the current sense signal CS and the input voltage detecting signal Vin-rec. In one embodiment, the logic control circuit 202 comprises a compensating circuit. The compensating circuit comprises an operational amplifier AMP, a resistor R1 and a capacitor C1. The compensating circuit compensates the feedback signal U_{F}. The compensated feedback signal is coupled to a first input terminal of a multiplier. A second input terminal of the multiplier is configured to receive the input voltage detecting signal Vin-rec. The multiplier multiplies the input voltage detecting signal Vin-rec with the compensated feedback signal, and generates a peak current limiting signal Vcom. The peak current limiting signal Vcom is coupled to the inverting input terminal of the second comparator Comp2. The non-inverting input terminal of the second comparator Comp2 is configured to receive the current sense signal CS. The second comparator Comp2 generates the reset signal R based on the comparison of the sense signal CS and the peak current limiting signal Vcom. The zero current detecting signal ZCD is coupled to the inverting input terminal of the first comparator Comp1. The non-inverting input terminal of the first comparator Comp1 receives the first reference signal VZ. The first comparator Comp1 generates the set signal based on the comparison of the first reference signal VZ and the zero current detecting signal ZCD. The RS flip-flop generates the switching signal “H” at the output terminal “Q” based on the set signal and the reset signal.

In the embodiment of FIG. 3A, when the switch S1 is ON, the power supply charges the inductor L1 through the loop formed by the inductor L1, the switch S1 and the switch S2; when the current sense signal CS reaches the peak current limiting signal Vcom, the switch S1 is turned OFF and the switch S3 is turned ON. Then the power supply charges the output capacitor Co through the loop formed by the inductor L1, the switch S3 and the switch S2, and supplies power to the load R_{L}. Meanwhile the inductor L1 is discharged. During the operation from the negative portion of the power supply, the switch S4 is ON: during when the switch S3 is ON, the power supply charged the inductor L1 through the loop formed by the inductor L1, the switch S3 and the switch S4; when the current sense signal CS reaches the peak current limiting signal Vcom, the switch S3 is turned OFF and the switch S1 is turned ON. Then the power supply charges the output capacitor Co through the loop formed by the inductor L1, the switch S1 and the switch S4, and supplies power to the load R_{L}. Meanwhile the inductor L1 is discharged.

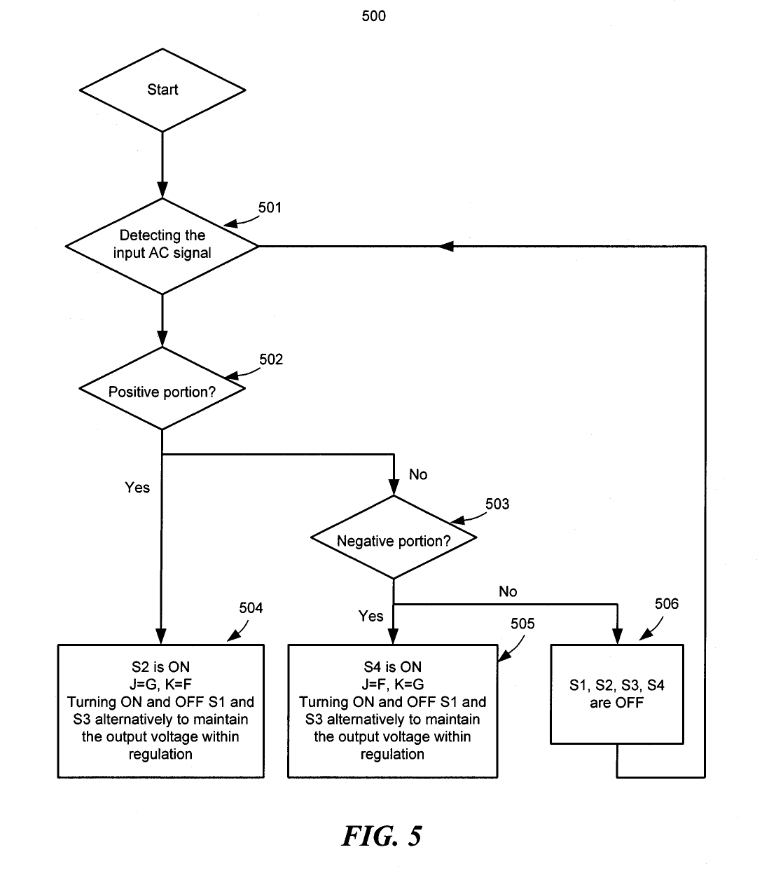

FIG. 5 schematically shows a flowchart of a method 500 of a voltage converter in accordance with an embodiment of the present disclosure. The method 500 comprises: step 501, detecting an input AC power supply by a differential sample circuit; step 502, if the input AC power supply is positive, turning ON a second switch S2 and turning OFF a fourth switch S4; step 503, if the input AC power supply is negative, turning ON the fourth switch S4 and turning OFF the second switch S2; step 504, when the second switch is ON, turning ON and OFF the first switch S1 and the third switch S3 alternatively to maintain the output voltage within regulation; step 505, when the fourth switch is ON, turning ON and OFF the first switch S1 and the third switch S3 alternatively to maintain the output voltage within regulation; step 506, setting a first dead time between the positive portion and the negative portion of the input AC power supply to ensure the switches S1˜S4 are all turned OFF to prevent a large current directly from the input AC power supply to the ground node, and to determine the state of the input AC power supply after the first dead time.

In one embodiment, the switches S1, S2, S3, S4 and the control circuit may be integrated together. In one embodiment, the control circuit is integrated and the switches S1, S2, S3 and S4 are implemented in discrete component circuit. In one embodiment, the switches S1, S2, S3, S4 and the control circuit are all implemented in discrete component circuit.

In the embodiments of the present disclosure, there are only two switches working during the whole operation. And one of the two switches works at low frequency, for example, approximately the same as the input AC power supply. The reduce of the frequency of the switches in the bridge arm reduces the switching loss, so that the efficiency of the power supplies realized in accordance with an embodiment of the present disclosure is improved. Thus, the circuits in accordance with embodiments of the present disclosure are especially suitable to the applications of high frequency and/or large current.

An effective technique for bridgeless PFC control has been disclosed. While specific embodiments of the present invention have been provided, it is to be understood that these embodiments are for illustration purposes and not limiting. Many additional embodiments will be apparent to persons of ordinary skill in the art reading this disclosure.

I/we claim:

1. A bridgeless PFC converter, comprising:
a first input terminal and a second input terminal configured to receive an input AC power supply;
an output terminal configured to provide an output signal;
an inductor having a first terminal and a second terminal, wherein the first terminal of the inductor is coupled to the first input terminal;
a high frequency bridge arm coupled between the output terminal and a ground node, wherein the high frequency bridge arm comprises a first switch and a third switch coupled in series, and the conjunction of the switches is coupled to the second terminal of the inductor;
a low frequency bridge arm coupled between the output terminal and the ground node, wherein the low frequency bridge arm comprises a second switch and a fourth switch coupled in series, and the conjunction of the switches is coupled to the second input terminal;
a differential sample circuit having a first input terminal, a second input terminal, a first output terminal and a second output terminal, wherein the first input terminal and the second input terminal are configured to receive the input AC power supply, and wherein based on the input AC power supply, the differential sample circuit generates a first detecting signal indicative of the positive portion of the input AC power supply at the first output terminal, and wherein the differential sample circuit generates a second detecting signal indicative of the negative portion of the input AC power supply at the second output terminal;
a logic control circuit configured to receive a feedback signal indicative of the output signal and a zero current detecting signal indicative of a current flowing through the inductor, wherein based on the feedback signal and the zero current detecting signal, the logic control circuit generates a switching signal;
a low frequency bridge arm control circuit having a first input terminal, a second input terminal, a first output terminal and a second output terminal, wherein the first input terminal is configured to receive the first detecting signal, the second input terminal is configured to receive the second detecting signal, and wherein based on the first detecting signal and the second detecting signal, the low frequency bridge arm control circuit generates a second switch control signal at the first output terminal and a fourth switch control signal at the second output terminal; and
a high frequency bridge arm control circuit having a first input terminal, a second input terminal, a third input terminal, a first output terminal and a second output terminal, wherein the first input terminal is coupled to the logic control circuit to receive the switching signal, the second input terminal is coupled to the low frequency bridge arm control circuit to receive the second switch control signal, the third input terminal is coupled to the low frequency bridge arm control circuit to receive the fourth switch control signal, and wherein based on the switching signal, the second switch control signal and the fourth switch control signal, the high frequency bridge arm generates a first switch control signal at the first output terminal, and a third switch control signal at the second output terminal; wherein
the first switch is controlled by the first switch control signal, the second switch is controlled by the second switch control signal, the third switch is controlled by the third switch control signal and the fourth switch is controlled by the fourth switch control signal.

2. The bridgeless PFC converter of claim 1, wherein the differential sample circuit further comprises:
a first amplifier having a first input terminal, a second input terminal and an output terminal, wherein the first and second input terminals are configured to receive the input AC power supply, and wherein based on the input AC power supply, the first amplifier generates the second detecting signal at the output terminal; and
a second amplifier having a first input terminal, a second input terminal and an output terminal, wherein the two input terminals are configured to receive the input AC power supply, wherein based on the input AC power supply, the second amplifier generates the first detecting signal at the output terminal.

3. The bridgeless PFC converter of claim 1, wherein the low frequency bridge arm control circuit further comprises:
a third comparator having a first input terminal, a second input terminal and an output terminal, wherein the first input terminal is coupled to the differential sample circuit to receive the second detecting signal, the second input terminal is configured to receive a first reference signal, and wherein based on the second detecting signal and the first reference signal, the third comparator generates the fourth switch control signal at the output terminal; and
a fourth comparator having a first input terminal, a second input terminal and an output terminal, wherein the first input terminal is coupled to the differential sample circuit to receive the first detecting signal, the second input terminal is configured to receive the first reference signal, and wherein based on the first detecting signal and the first reference signal, the fourth comparator generates the second switch control signal at the output terminal.

4. The bridgeless PFC converter of claim 2, wherein the high frequency bridge arm control circuit further comprises a synchronous driver having an input terminal, a first output terminal and a second output terminal, wherein the input terminal is configured to receive the switching signal, and wherein based on the switching signal, the synchronous driver generates a first control signal at the first output terminal and a second control signal at the second output terminal.

5. The bridgeless PFC converter of claim 4, wherein the high frequency bridge arm control circuit further comprises a signal selector configured to receive the first control signal, the second control signal, the second switch control signal and the fourth switch control signal, wherein based on the first control signal, the second control signal, the second switch control signal and the fourth switch control signal, the signal selector generates the first switch control signal at the first output terminal and the third switch control signal at the second output terminal.

6. The bridgeless PFC converter of claim 5, wherein the signal selector comprises:
a first SPDT switch having a first terminal, a second terminal, a third terminal and a control terminal, wherein the first terminal is configured to receive the second control signal, and the control terminal is configured to receive the second switch control signal;
a second SPDT switch having a first terminal, a second terminal, a third terminal and a control terminal, wherein the first terminal is configured to receive the first control signal, and the control terminal is configured to receive the second switch control signal;
an OR gate having a first input terminal, a second input terminal and an output terminal, wherein the first input terminal is configured to receive the fourth switch control signal and the second input terminal is configured to receive the second switch control signal;
a first AND gate having a first input terminal, a second input terminal and an output terminal; and
a second AND gate having a first input terminal, a second input terminal and an output terminal; wherein
the second terminal of the first SPDT switch and the third terminal of the second SPDT switch are both coupled to the first input terminal of the first AND gate, the second terminal of the second SPDT switch and the third terminal of the first SPDT switch are both coupled to the first input terminal of the second AND gate, the output terminal of the OR gate is coupled to the second terminal of the first AND gate and the second terminal of the second AND gate;
the first switch control signal is generated at the output terminal of the first AND gate; and
the third switch control signal is generated at the output terminal of the second AND gate.

7. A bridgeless PFC converter comprising:
a first input terminal and a second input terminal configured to receive an input AC power supply;
an output terminal configured to provide an output signal;
an inductor having a first terminal and a second terminal, wherein the first terminal of the inductor is coupled to the first input terminal;
a high frequency bridge arm coupled between the output terminal and a ground node, wherein the high frequency bridge arm comprises a first switch and a third switch coupled in series, and the conjunction of the switches is coupled to the second terminal of the inductor;
a low frequency bridge arm coupled between the output terminal and the ground node, wherein the low frequency bridge arm comprises a second switch and a fourth switch coupled in series, and the conjunction of the switches is coupled to the second input terminal;
a current sense circuit coupled between the second switch and the fourth switch to sense the current flowing through the second switch and the fourth switch and to generate a current sense signal based thereupon;
a differential sample circuit having a first input terminal, a second input terminal, a first output terminal and a second output terminal, wherein the first input terminal and the second input terminal are configured to receive the input AC power supply, and wherein based on the input AC power supply, the differential sample circuit generates a first detecting signal indicative of the positive portion of the input AC power supply at the first output terminal and a second detecting signal indicative of the negative portion of the input AC power supply at the second output terminal;
a summing circuit having a first input terminal, a second input terminal and an output terminal, wherein the first input terminal is coupled to the output terminal of the first amplifier to receive the second detecting signal, the second input terminal is coupled to the output terminal of the second amplifier to receive the first detecting signal, and wherein based on the first detecting signal, the second detecting signal, the summing circuit generates an input voltage detecting signal;
a logic control circuit coupled to receive a feedback signal indicative of the output signal, the current sense signal, a zero current detecting signal indicative of a zero current flowing through the inductor and the input voltage detecting signal, wherein based on the feedback signal, the current sense signal, the zero current detecting signal and the input voltage detecting signal, the logic control circuit generates a switching signal;
a low frequency bridge arm control circuit having a first input terminal, a second input terminal, a first output terminal and a second output terminal, wherein the first input terminal is configured to receive the first detecting signal, the second input terminal is configured to receive the second detecting signal, and wherein based on the first detecting signal and the second detecting signal, the low frequency bridge arm control circuit generates a second switch control signal at the first output terminal and a fourth switch control signal at the second output terminal; and
a high frequency bridge arm control circuit having a first input terminal, a second input terminal, a third input terminal, a first output terminal and a second output terminal, wherein the first input terminal is coupled to the logic control circuit to receive the switching signal, the second input terminal is coupled to the low frequency bridge arm control circuit to receive the second switch control signal, the third input terminal is coupled to the low frequency bridge arm control circuit to receive the fourth switch control signal, and wherein based on the switching signal, the second switch control signal and the fourth switch control signal, the high frequency bridge arm generates a first switch control signal at the first output terminal, and a third switch control signal at the second output terminal; wherein
the first switch is controlled by the first switch control signal, the second switch is controlled by the second switch control signal, the third switch is controlled by the third switch control signal and the fourth switch is controlled by the fourth switch control signal.

8. The bridgeless PFC converter of claim 7, wherein the differential sample circuit comprises:
a first amplifier having a first input terminal, a second input terminal and an output terminal, wherein the two input terminals are configured to receive the input AC power supply, and wherein based on the input AC power supply, the first amplifier generates a second detecting signal at the output terminal;
a second amplifier having a first input terminal, a second input terminal and an output terminal, wherein the two input terminals are configured to receive the input AC power supply, wherein based on the input AC power supply, the second amplifier generates a first detecting signal at the output terminal.

9. The bridgeless PFC converter of claim 7, wherein the low frequency bridge arm control circuit further comprises:
a third comparator having a first input terminal, a second input terminal and an output terminal, wherein the first input terminal is coupled to the differential sample circuit to receive the second detecting signal, the second input terminal is configured to receive a first reference signal, and wherein based on the second detecting signal and the first reference signal, the third comparator generates the fourth switch control signal at the output terminal; and
a fourth comparator having a first input terminal, a second input terminal and an output terminal, wherein the first input terminal is coupled to the differential sample circuit to receive the first detecting signal, the second input terminal is configured to receive the first reference signal, and wherein based on the first detecting signal and the first reference signal, the fourth comparator generates the second switch control signal at the output terminal.

10. The bridgeless PFC converter of claim 8, wherein the high frequency bridge arm control circuit further comprises a synchronous driver having an input terminal, a first output terminal and a second output terminal, wherein the input terminal is configured to receive the switching signal, and wherein based on the switching signal, the synchronous driver generates a first control signal at the first output terminal and a second control signal at the second output terminal.

11. The bridgeless PFC converter of claim 10, wherein the high frequency bridge arm control circuit further comprises a signal selector configured to receive the first control signal, the second control signal, the second switch control signal and the fourth switch control signal, wherein based on the first control signal, the second control signal, the second switch control signal and the fourth switch control signal, the signal selector generates the first switch control signal at the first output terminal and the third switch control signal at the second output terminal.

12. The bridgeless PFC converter of claim 11, wherein the signal selector comprises:
a first SPDT switch having a first terminal, a second terminal, a third terminal and a control terminal, wherein the first terminal is configured to receive the second control signal, and the control terminal is configured to receive the second switch control signal;
a second SPDT switch having a first terminal, a second terminal, a third terminal and a control terminal, wherein the first terminal is configured to receive the first control signal, and the control terminal is configured to receive the second switch control signal;
an OR gate having a first input terminal, a second input terminal and an output terminal, wherein the first input terminal is configured to receive the fourth switch control signal and the second input terminal is configured to receive the second switch control signal;
a first AND gate having a first input terminal, a second input terminal and an output terminal; and
a second AND gate having a first input terminal, a second input terminal and an output terminal; wherein
the second terminal of the first SPDT switch and the third terminal of the second SPDT switch are both coupled to the first input terminal of the first AND gate, the second terminal of the second SPDT switch and the third terminal of the first SPDT switch are both coupled to the first input terminal of the second AND gate, the output terminal of the OR gate is coupled to the second terminal of the first AND gate and the second terminal of the second AND gate;
the first switch control signal is generated at the output terminal of the first AND gate; and
the third switch control signal is generated at the output terminal of the second AND gate.

13. A method of controlling a bridgeless PFC converter, wherein the bridgeless PFC converter comprises a first input terminal and a second input terminal configured to receive an input AC power supply; an output terminal configured to provide an output signal; an inductor having a first terminal and a second terminal, wherein the first terminal of the inductor is coupled to the first input terminal; a high frequency bridge arm coupled between the output terminal and a ground node, wherein the high frequency bridge arm comprises a first switch and a third switch coupled in series, and the conjunction of the switches is coupled to the second terminal of the inductor; a low frequency bridge arm coupled between the output terminal and the ground node, wherein the low frequency bridge arm comprises a second switch and a fourth switch coupled in series, and the conjunction of the switches is coupled to the second input terminal; the method comprising:
generating a first detecting signal indicative of the position portion of the input AC power supply;
generating a second detecting signal indicative of the negative portion of the input AC power supply;
turning ON the second switch when the first detecting signal is higher than a first reference signal and turning OFF the second switch when the first detecting signal is lower than the first reference signal;
turning ON the fourth switch when the second detecting signal is higher than the first reference signal and turning OFF the fourth switch when the second detecting signal is lower than the first reference signal;
during when the second switch is ON, turning ON the first switch at the beginning of a switching cycle and turning ON the third switch when the current flowing through the inductor decreases to zero; and
during when the fourth switch is ON, turning ON the third switch at the beginning of the switching cycle and turning ON the first switch when the current flowing through the inductor decreases to zero; and
wherein the first switch and the third switch are turned ON and OFF alternatively.

14. The method of controlling a bridgeless PFC converter of claim 13, further comprising:
setting a first dead time between the OFF of the second switch and the ON of the fourth switch;
setting a second dead time between the OFF of the fourth switch and the ON of the second switch;
setting a third dead time between the OFF of the first switch and the ON of the third switch; and
setting a fourth dead time between the OFF of the first switch and the ON of the first switch.

15. A method of controlling a bridgeless PFC converter, wherein the bridgeless PFC converter comprises a first input terminal and a second input terminal configured to receive an input AC power supply; an output terminal configured to provide an output signal; an inductor having a first terminal and a second terminal, wherein the first terminal of the inductor is coupled to the first input terminal; a high frequency bridge arm coupled between the output terminal and a ground node, wherein the high frequency bridge arm comprises a first switch and a third switch coupled in series, and the conjunction of the switches is coupled to the second terminal of the inductor; a low frequency bridge arm coupled between the output terminal and the ground node, wherein the low frequency bridge arm comprises a second switch and a fourth switch coupled in series, and the conjunction of the switches is coupled to the second input terminal; the method comprising:
generating a first detecting signal indicative of the position portion of the input AC power supply;
generating a second detecting signal indicative of the negative portion of the input AC power supply;
summing the first detecting signal and the second detecting signal to generate a peak current limiting signal;
turning ON the second switch when the first detecting signal is higher than a first reference signal and turning OFF the second switch when the first detecting signal is lower than the first reference signal;
turning ON the fourth switch when the second detecting signal is higher than the first reference signal and turning OFF the fourth switch when the second detecting signal is lower than the first reference signal;
during when the second switch is ON, turning ON the third switch when the current flowing through the inductor decreases to zero and turning ON the first switch when the current flowing through the inductor reaches the value of the peak current limiting signal;
during when the fourth switch is ON, turning ON the first switch when the current flowing through the inductor decreases to zero and turning ON the third switch when the current flowing through the inductor reaches the value of the peak current limiting signal; wherein
the first switch and the third switch are turned ON and OFF alternatively.

16. The method of controlling a bridgeless PFC converter of claim 15, further comprises:
setting a first dead time between the OFF of the second switch and the ON of the fourth switch;
setting a second dead time between the OFF of the fourth switch and the ON of the second switch;
setting a third dead time between the OFF of the first switch and the ON of the third switch;
setting a fourth dead time between the OFF of the first switch and the ON of the first switch.
